(19) United States
(12) Patent Application Publication
(10) Pub. No.: US 2014/0168536 A1
(43) Pub. Date: Jun. 19, 2014

(54) SINGLE-LAYER ELECTRODE MUTUAL CAPACITIVE TOUCH SCREEN

(71) Applicant: FocalTech Systems, Ltd., Grand Cayman (KY)

(72) Inventors: Ming Guo, Shenzhen (CN); Hua Li, Shenzhen (CN); Rong Chen, Shenzhen (CN)

(21) Appl. No.: 14/014,576

(22) Filed: Aug. 30, 2013

(30) Foreign Application Priority Data
Aug. 31, 2012 (CN) 201210318082.5

(51) Int. Cl. G06F 1/16; G06F 3/044

(52) U.S. Cl. CPC G06F 1/169; G06F 3/044
USPC 349/12

(57) ABSTRACT

A single-layer electrode mutual capacitive touch screen comprises the first-class electrodes and the second-class electrodes, connecting conductors and data processing module. Both of the said first-class electrodes and second-class electrodes are electrically connected to the data processing module. In particular, any of the said first-class electrode and second-class electrode are set in the touch region of the touch screen without overlapping each other. There is no positional relation of crossover, spanning and intersection between first connecting conductors for the respective first-class electrodes, second connecting conductors for the respective second-class electrodes, and connecting conductors of any first-class electrode and second-class electrode in the touch region of the touch screen. The invention has realized single-layer mutual capacitive touch screen which is set with electrode supporting multi-point touch. Because there is no bridging structure, light transmittance consistency for the touch screen is great. Adoption of the structure for the invention has omitted technical processes for mutual capacitive touch screen manufacturing of the existing technology, meanwhile, due to relatively simple electrode manufacturing, production cost for the single-layer mutual capacitive touch screen is reduced.

The present application claim priority of Chinese patent application Serial No. 201210318082.5, filed Aug. 31, 2012, the content of which is hereby incorporated by reference in its entirely.

### TECHNICAL FIELD

The invention relates to a touch input device, especially an electrode arrangement structure for the touch screen which is able to support multi-point touch.

### BACKGROUND ART

Capacitive electrode layer for the capacitive touch screen is made of transparent metallic oxide Indium Tin Oxide (ITO for short). As to mutual capacitance detection, mutual capacitance is formed by interchangeable linear electrode channel X and linear electrode channel Y, and the two kinds of linear electrode channels are respectively named as drive wire Driver and induction wire Sensor. Under general circumstance, capacitance matrix is formed from electrode channel X and electrode channel Y which is of orthorhombic structure. As shown in FIG. 8, several electrode channels X, X1 to X5, and several electrode channels Y, Y1 to Y5 have formed several mutual capacitive CM nodes, which are monitoring points for change in capacitance. The said mutual capacitance CM nodes are evenly and regularly distributed. If touch occurs at the indicating area P or Q, data processing module of the touch screen will collect change in capacitance for several monitoring points, calculate variable quantity of capacitance at touch occurrence points by means of various algorithms, and obtain accurate touch coordinate data, thus, multi-point touch can be detected.

As shown in FIG. 9, with respect to the capacitive touch screen supporting multi-point touch of the prior art, there is a double layer ITO mutual capacitive touch screen, whose driving channel and sensing channel are respectively made of two layers of ITO conductive material, and are respectively set on the two non-coplanar parallel surfaces, namely Double Layer ITO touch screen, DITO touch screen for short; and as shown in FIG. 10, there is still another kind of single-layer mutual capacitive touch screen, whose two kinds of electrode channels are respectively made from ITO conducting material, and are set on the same plane, namely Single layer ITO touch screen, SITO for short. Specifically, electrode channels for the DITO touch screen is made of two layers of ITO which are overlapped, one layer of ITO is the driving electrode, and the other layer is the sensing electrode. Between the two layers of ITO, there is an insulating layer made of glass or composite film and other transparent materials, driving electrode and sensing electrode are orthogonally distributed, forming coupled mutual capacitance CM at nodes. It appears that driving electrode and sensing electrode of the SITO touch screen is only made from one layer of ITO, and coupled capacitance CM is of complementary crossover pattern; nevertheless, actually capacitance matrix for driving electrode and sensing electrode is required to be orthogonally, so, channels for driving electrode and sensing electrode can only be connected via bridging 8. At present, there is still another single-layer ITO capacitive touch screen as shown in FIG. 11, whose electrode channels are composed of right triangular-alike electrodes 9. The said electrodes 9 are set in pairs, bevel edges of one pair of electrodes 9 are set in parallel, forming rectangular electrode pairs, and respective electrodes pairs are set in parallel. Such proposal fail to realize horizontal multi-point touch, therefore, during practical application, it can only support single point touch aided by gesture, i.e. the proposal as shown in FIG. 11 can only support capacitive touch screen with single-point touch.

Obviously, there are defects and deficiencies for the aforementioned three mutual capacitive touch screen proposals with respect to the prior art:

DITO mutual capacitive touch screen requires electrodes made from two layers of ITO, production technology for the touch screen is complicated, and production yield is restricted by the production technology; SITO mutual capacitive touch screen is not the single-layer electrode arrangement of real sense, whose channels are required to be connected via bridging, production technology is complicated, production yield is low, and there is vision difference between bridging and non-bridging part, so that both the two parts are visible to the users, inconsistent with the touch screen requirements. As shown in FIG. 11, although, mutual capacitive touch screen is the solution to realize single-layer ITO touch screen, such touch screen can only support single-point plus gesture entry, fails to realize authentic multi-point touch, which is nonconformance with market requirements and fails to be popularized with touch screen.

### CONTENT OF THE INVENTION

In view of the above-described problems, the aim of the invention are to avoid defeats in the prior art and to provide a capacitive touch screen which is composed of single-layer conductive material and can support multi-point touch, reducing total cost of the touch screen by means of avoiding the deficiencies of the prior art.

The purpose of the invention is achieved by the following technical schemes:

Design and manufacture a single-layer electrode mutual capacitive touch screen, comprising at least one first-class electrode and one second-class electrode coupled with each other, which are made of transparent conductive material distributed in the same plane, first connecting conductors made of transparent conductive material respectively electrically connected to the respective first-class electrodes, second connecting conductors made of transparent conductive material respectively electrically connected to the respective second electrodes as well as a data processing module. Both of the said first-class electrodes and second-class electrodes are electrically connected to the data processing module. In particular, any of the said first-class electrode and second-class electrode is set in the touch region of the touch screen without overlapping each other. There is no positional relation of crossover, spanning and intersection between the first connecting conductors of the respective first electrodes, the second connecting conductors of the respective second electrodes, and connecting conductors between any first electrode and second electrode in the touch region of the touch screen.

Specifically, the said data processing module is composed of a driving module for sending excitation signal, and a sensing module for receiving signal fed back from excitation signal; any of the said first-class electrode and second-class electrode is electrically connected to the said driving module, and another electrode is electrically connected to the said sensing module.

As to a concrete realization proposal, the said first-class electrodes are electrically connected to be the first electrode chains in serial in groups by virtue of the first connecting conductors, at least two respective centre lines of which are parallel to each other. Centre lines of the said first electrode chains are lines connecting centroids consisting first-class electrodes of the respective first electrode chains. By virtue of the first connecting conductors of the first-class electrodes at the end of the said first electrode chains, the said first-class electrode chains are connected to the said data processing module. The said second-class electrodes are set between the two adjacent first electrode chains and/or at the outside of the most outside of the two first electrode chains. Second connecting conductors which are electrically connected to the respective second-class electrodes are set in parallel in the touch region of the touch screen, and are electrically connected to the said data processing module.

As to the other concrete realization proposal, the said first-class electrodes are electrically connected to be the first electrode chains in serial in groups by virtue of the first connecting conductors, at least two respective centre lines of which are parallel to each other. Centre lines of the said first electrode chains are lines connecting centroids of the respective first-class electrodes consisting first electrode chains. By virtue of the first connecting conductors of the first-class electrodes at the end of the said first electrode chains, the said first electrode chains are connected to the said data processing module. The said first-class electrode is provided with a hollow electrode accommodating area, and at least one wire slot is set for the first-class electrode, by virtue of the wire slot, the electrode accommodating areas located in the said first-class electrodes are connected to the area at the outside of the first-class electrodes. The said second-class electrodes are set inside of the electrode accommodating areas corresponding to the second-class electrodes, second connecting conductors which are electrically connected to the said second-class electrodes are led out from the wire slots of the said first-class electrodes and connected to the said data processing module; and second connecting conductors electrically connected to the respective second-class electrodes are set in parallel in the area which is at the outside of the first-class electrodes.

For the above two proposals, the said first-class electrodes are of planar shape. In one of the first electrode chain, planar borders of the mutually adjacent first-class electrodes are electrically connected, i.e. there is no first connecting conductor between the adjacent first-class electrodes of the first electrode chains, thus, first electrode chains are long striped planes.

As regarding the touch screen realization proposal for the aforementioned hollowed first-class electrodes, the said second-class electrode comprises at least two sub-electrodes, and the connecting electrodes set between the two adjacent electrodes. The said sub-electrodes are the planes with the first centre lines perpendicular to the second centre lines. Length of the first centre line segment for the said sub-electrode which is collinear with the first centre line is shorter than length of the second centre line segment for the sub-electrode which is collinear with the second centre line. Respective second centre lines of the said sub-electrodes are set in parallel. Taking the direction where the second centre lines of the said sub-electrodes are located as the width direction, width of the said connecting electrodes is smaller than length of the second centre line segments which are collinear with the second centre lines of the said electrodes. Planar borders between the said sub-electrodes and connecting electrodes are electrically by virtue of the mutually adjacent planar borders, thus, the said second-class electrodes are planes with at least one groove. Border shape of the electrode accommodating areas of the first-class electrodes corresponding to the said second-class electrodes are matched with the planar border shape of the second-class electrodes, thus borders of the said electrode accommodating areas are of zigzag shape.

As to the structural scheme of a sub-electrode, the said sub-electrodes are diamond-alike sub-electrodes with opposite angles cut off, i.e. the said diamond-alike sub-electrode is a hexagon shaped from a diamond whose angles at both sides of the second centre line are cut off by a pair of straight lines which are parallel to the said second centre line; the said connecting electrodes are rectangular connecting electrodes.

For the structural scheme of the other kind of sub-electrode, the said sub-electrodes are rectangular and the said connecting electrodes are rectangular.

As to the realization proposal for touch screen of the hollowed first-class electrode, respective wire slots for first-class electrodes are placed at one side or both sides of the first electrode chains

The said transparent conductive material is Indium Tin Oxide, ITO for short, or Antimony Tin Oxide, ATO for short.

Compared to the prior art, technical effect of the invention entitled “A time slot scanning mode enabling the capacitive touch screen to execute multiple scanning modes” is that:

First electrodes and second electrodes of the invention are placed in the touch region without overlapping each other. There is no positional relation of spanning, crossover and intersection in the touch region, thus, single-layer mutual capacitive touch screen with electrode supporting multi-point touch can be realized in real sense. Due to lack of bridging structure, light transmittance consistency of the touch screen is satisfactory, so electrode structure of the touch screen is invisible to users; the adoption of the invention structure has omitted technical processes for mutual capacitive touch screen manufacturing of the prior art, meanwhile, electrodes are manufactured in a simple way, thus, production cost for single-layer mutual capacitive touch screen is reduced.

### DESCRIPTION OF FIGURES

FIG. 1: Electrode arrangement structure diagram for a kind of realization mode for “single-layer electrode mutual capacitive touch screen” of the invention;

FIG. 2 Electrode arrangement structure diagram for the other kind of realization mode for the invention;

FIG. 3: Structure diagram for a mutual capacitive coupled unit of the first embodiment of the invention;

FIG. 4: Structure diagram for the first electrode 11 of the first embodiment of the invention;

FIG. 5: Structure diagram for the second electrode 21 of the first embodiment of the invention;

FIG. 6: Structure diagram for a mutual capacitive coupled unit of the second embodiment of the invention;

FIG. 7: Structure diagram for the second electrode 21 of the second embodiment of the invention;

FIG. 8: Electrode structure principle diagram for the prior art-mutual capacitive touch screen;

FIG. 9: Electrode structure principle diagram for the prior art-DITO mutual capacitive touch screen;

FIG. 10: Electrode structure principle diagram for the prior art-SITO mutual capacitive touch screen;

FIG. 11: Electrode structure principle diagram for single layer mutual capacitive touch screen of the prior art which supports single-point touch.

### MODE OF CARRYING OUT THE INVENTION MODEL

To further illustrate the principle and structure of the invention, the invention is further described in detail in accordance with the preferable embodiments shown in the figures.

The invention realizes real multi-point touch by means of forming capacitance matrix on the touch screen, utilizing real-time monitoring technology and central algorithm Based on such principle, capacitor array matrix shall be formed on the touch screen, and driving electrode channel and sensing electrode channel shall not be criss-cross on the screen. More specifically, independent coupling capacitance units shall be formed on the screen, led out by ITO wire, and electrically connected to the outside of the screen, rather than traditional crisscross electrode arrangement structure formed by inductive material.

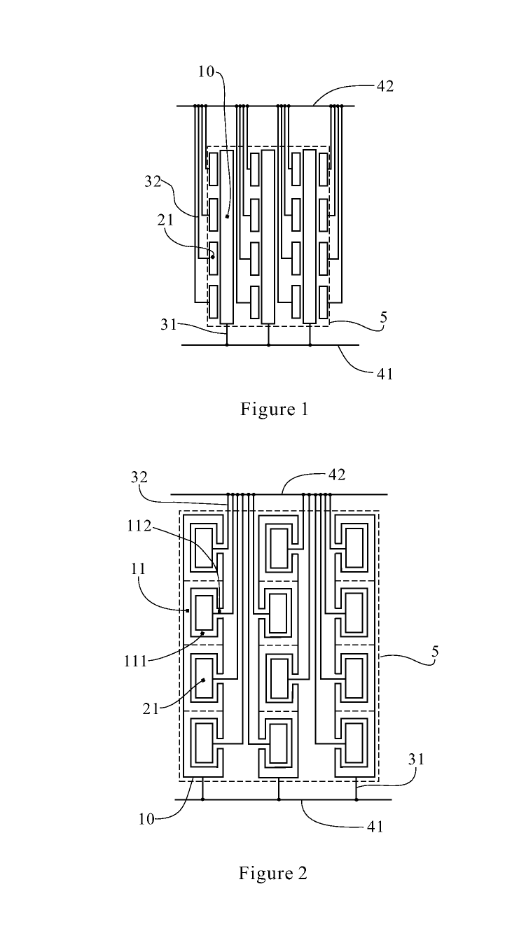

As shown in FIG. 1 and FIG. 2, single-layer electrode mutual capacitive touch screen of the invention comprises at least one first-class electrode 11 and at least one second-class electrode 21 coupled with each other which are made of transparent conductive material distributed in the same plane, the first connecting conductors 31 made of transparent conductive material respectively and electrically connected to the respective first-class electrodes 11, the second connecting conductors 32 made of transparent conductive material respectively and electrically connected to the respective second-class electrodes 21 as well as a data processing module. Both of the said first-class electrodes 11 and second-class electrodes 21 are electrically connected to the data processing module. In particular, any of the said first-class electrode 11 and second-class electrode 21 are set in the touch region 5 of the touch screen without overlapping each other. There is no positional relation of crossover, spanning and intersection between the first connecting conductors 31 of the respective first electrodes 11, the second connecting conductors 32 of the respective second electrodes 21, and connecting conductors 31 and 32 between any first-class electrode 11 and second-class electrode 21 in the touch region of the touch screen. The simplest way of realizing the positional relation of no crossover, no spanning and no intersection of the connecting conductors is parallel set.

The said transparent conductive material is Indium Tin Oxide, ITO for short, or Antimony Tin Oxide, ATO for short.

The said data processing module is composed of a driving module for sending excitation signal, and a sensing module for receiving signal fed back from excitation signal; any of the said first-class electrode 11 and second-class electrode 21 is electrically connected to the said driving module, and the other kind of electrode is electrically connected to the said sensing module.

As to the invention, most basic mutual capacitance coupling unit is composed of at least one pair of first-class electrodes 11 and second-class electrodes 21, connecting conductors for the first-class electrodes 11 and second-class electrodes 21 are reduced as much as possible, connecting conductors are set in parallel without crossover, spanning and intersection, and electrical signals for the mutual capacitance coupling unit are led out of the touch region with connecting conductors. There is no bridging structure for the invention, realizing real sense mutual capacitive touch screen which is composed of electrodes made of single-layer transparent conductive material and can support multi-point touch. The said crossover positional relation puts emphasis on the two-dimensional relation in which two conductors in the same plane intersect and contact at one point. The said positional relation of spanning and intersection emphasizes on 3D positional relation in which two conductors in the space intersect but do not contact.

As to a concrete realization proposal as shown in FIG. 1, the said first-class electrodes 11 are electrically connected to be the first electrode chains in serial in groups by virtue of the first connecting conductors 31, at least two respective centre lines of which are parallel to each other. Centre lines of the said first electrode chains 10 are lines connecting centroids of respective first electrodes 11 consisting the first electrode chains 10. By virtue of the first connecting conductors 31 which are electrically connected to the first-class electrodes 11 at the end of the said first electrode chains 10, the said first electrode chains 10 are electrically connected to conductors 41 at the outside of touch region 5. Then, respective first electrode chains 10 are electrically connected to the said data processing module via the conductors 41. The said second-class electrodes 21 are set between the adjacent two first electrode chains 10 and/or at the respective outside of the most outside two first electrode chains 10. As shown in FIG. 1, as to the condition where the said second electrodes 21 are set between the adjacent two first electrode chains 10 and at the respective outside of the most outside two electrode chains 10, the second electrodes 21 are only set between the adjacent two first electrode chains 10, while, the circumstance where the second electrode chains 21 are not set at the respective outside of the most outside two adjacent electrode chains 10 is another structural scheme which is easy to be realized. The second connecting conductors 32 electrically connected to the respective second electrode 21 are set in parallel to each other in the touch region of the touch screen, and are electrically connected to the said data processing module via the conductors 42 at the outside of the touch region 5. The above concrete realization proposal of the invention is simple and practicable, which belongs to the proposal of principle nature.

As shown in FIG. 1, to reduce connecting conductors in the touch region as much as possible, the said first-class electrodes 11 are of planar shape. Pin one first electrode chain 10, planar borders of the adjacent first-class electrodes 11 are electrically connected, by virtue of the adjacent planar borders, namely there is no first connecting conductor 32 between the two adjacent first electrodes 11 in the first electrode chain 10, thus, the said first electrode chains 10 are long striped plane. The above statement only describes the structure of the first electrode chains 10. During practical manufacturing, a rectangular plane electrode can be directly served as the first electrode chain 10, needless of connection between the adjacent first electrodes 11.

As to another concrete realization proposal as shown in FIG. 2 for the invention, the said first electrodes 11 are electrically connected to be the first electrode chains 10 in serial in groups by virtue of the first connecting conductors 31, at least two respective centre lines of which are parallel to each other. Centre lines of the said first electrode chains 10 are lines connecting centroids of respective first electrode 11 consisting the first electrode chains 10. By virtue of the first connecting conductors 31 of the first electrodes 11 at the end of the said first electrode chains 10, the said first electrode chains 10 are electrically connected to conductors 41 at the outside of touch region 5. Then, respective first electrode chains 10 are electrically connected to the said data processing module via the conductors 41. The said first electrode 11 is set with a hollowed electrode accommodating area 111, and the first electrode 11 is set with at least one wire slot 112, electrode accommodating area 111 in the said first electrode 11 is connected with the area at the outside of the first electrode 11 via the wire slot 112. The said second-class electrodes 21 are set in the electrode accommodating areas 111 of the first-class electrodes 11 which are corresponding to the second-class electrode 21. The second connecting conductors 32 electrically connected to the said second electrodes 21 are led out from the wire slots 112 of the first-class electrodes 11 and electrically connected to the said data processing module via conductors 42 at the outside of the touch region 5. And second connecting conductors 32 electrically connected to the respective second-class electrodes 21 are set in parallel in the area at the outside of the first-class electrodes 11. The above concrete realization proposal is the optimum proposal of the proposal as shown in FIG. 1, which can strength the coupling effect of the first-class electrodes 11 and second-class electrodes 21, improving effective permittivity.

As shown in FIG. 2, to reduce connecting conductors in the touch region 5 much as possible, the said first-class electrodes 11 are of planar shape. Planar borders of the adjacent first-class electrodes 11 in the first electrode chains 10 are electrically connected, by virtue of the adjacent planar borders, namely there is no first connecting conductor 32 between the two adjacent first-class electrodes 11 in the first electrode chain 10, thus, the said first electrode chains 10 are long striped plane. The above statement only describes the structure of the first electrode chains 10. During practical manufacturing, a rectangular plane electrode can be directly served as the first electrode chain 10, needless of connection between the adjacent first electrodes 11. Planar borders of the adjacent first electrodes 11 in a first electrode chain 10 are electrically connected by virtue of the adjacent planar borders, namely, there is no first connecting conductor 32 between the adjacent first electrodes 11 in the first electrode chain 10, thus, first electrode chain 10 are of long striped shape. The above statement only describes the structure of the first electrode chains 10. During practical manufacturing, a rectangular plane electrode can be directly served as the first electrode chain 10, needless of connection between the adjacent first-class electrodes 11.

As shown in FIG. 2, respective wire slots 112 of the said first-class electrodes 11 can be set at one side of the first electrode chains 10, FIG. 2 has shown the condition for first electrode chains 10 at both sides; respective wire slots 112 of the said first-class electrodes 11 can also be set at both sides of the first electrode chains 10, FIG. 2 has shown the condition for first electrode chains 10 at central part.

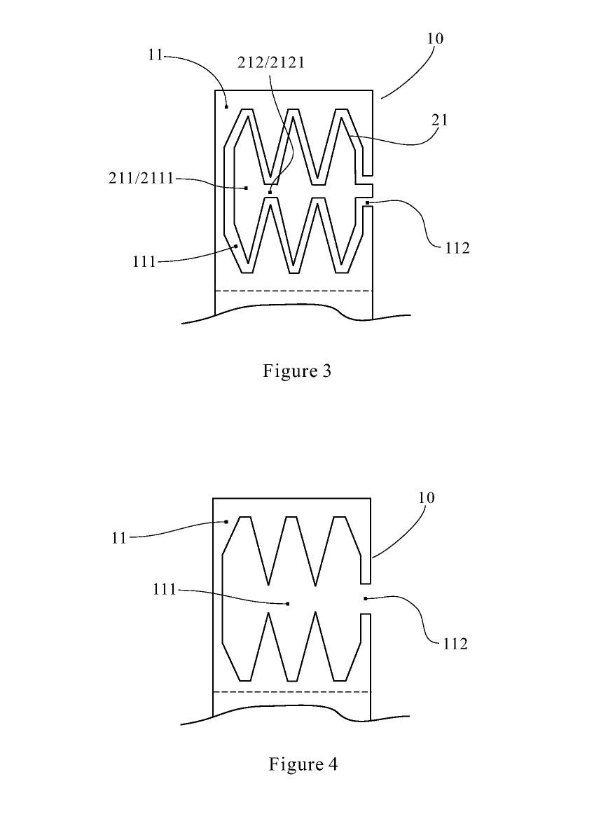

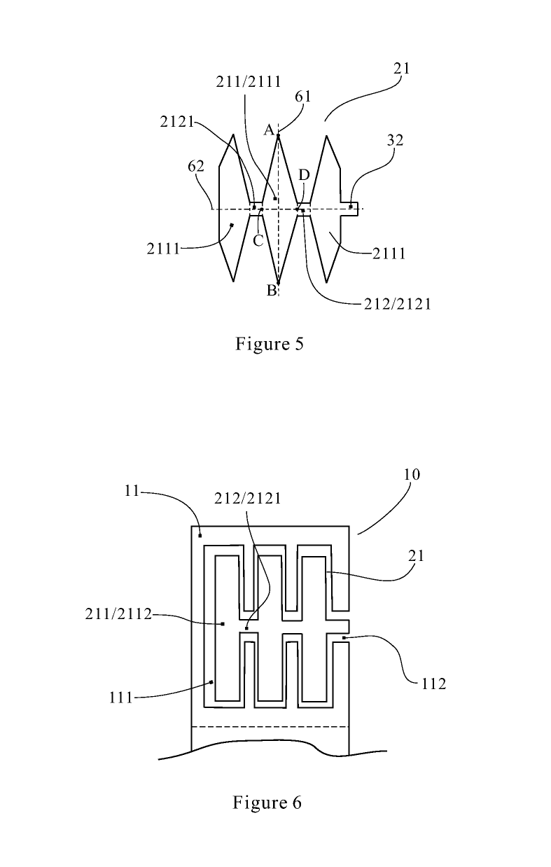

To enhance coupling effect in a better way and improve the effective permittivity, in the first embodiment as shown from FIG. 3-FIG. 7, as to one basic coupling unit, the said second-class electrode 21 comprises at least two sub-electrodes and connecting electrode 212 which is set between the adjacent two sub-electrodes 211. The said sub-electrode 211 is the plane whose first centre line and second centre line are perpendicular. Length of the first centre line segment AB for the said sub-electrode 211 which is collinear with the first centre line is shorter than length of the second centre line segment CD which is collinear with the second centre line. Respective second centre lines for the said sub-electrode 211 are set in parallel. Taking the direction where the second centre line is located for the said sub-electrode 211 as the width direction, width for the said connecting electrode 212 is smaller than the length of the second centre line segment CD for the said sub-electrode 211 which is collinear with the second centre line. Planar borders between the said sub-electrode 211 and the connecting electrode 212 are electrically connected by virtue of the adjacent planar borders, thus, the said second electrodes 21 are of planar shape with at least one groove; border shape of the electrode accommodating areas 111 for the first-class electrodes 11 corresponding to the said second-class electrodes 21 are matched with the planar border shape of the second-class electrodes 21, thus, border of the said electrode accommodating area 111 is of zigzag shape.

For the first embodiment as shown from FIG. 3 to FIG. 5, the said sub-electrode 211 is diamond-alike sub-electrode 2111 with opposite angles cut off, i.e. the diamond-alike sub-electrode 2111 is a hexagon obtained from a diamond whose angles at both sides of the second centre line are cut off by a pair of straight lines parallel to the said second centre line. The said connecting electrode 212 is rectangular connecting electrode 2121.

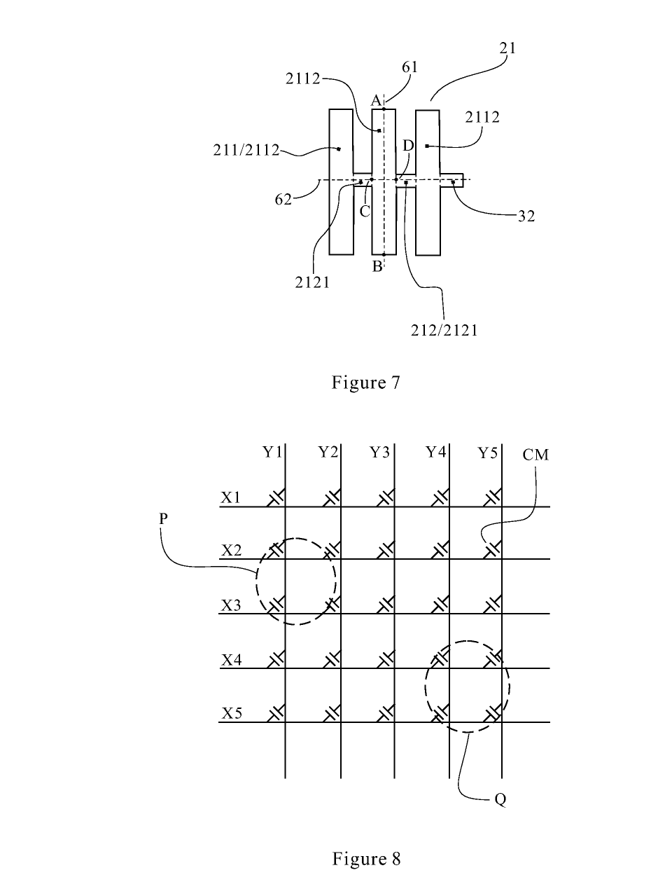

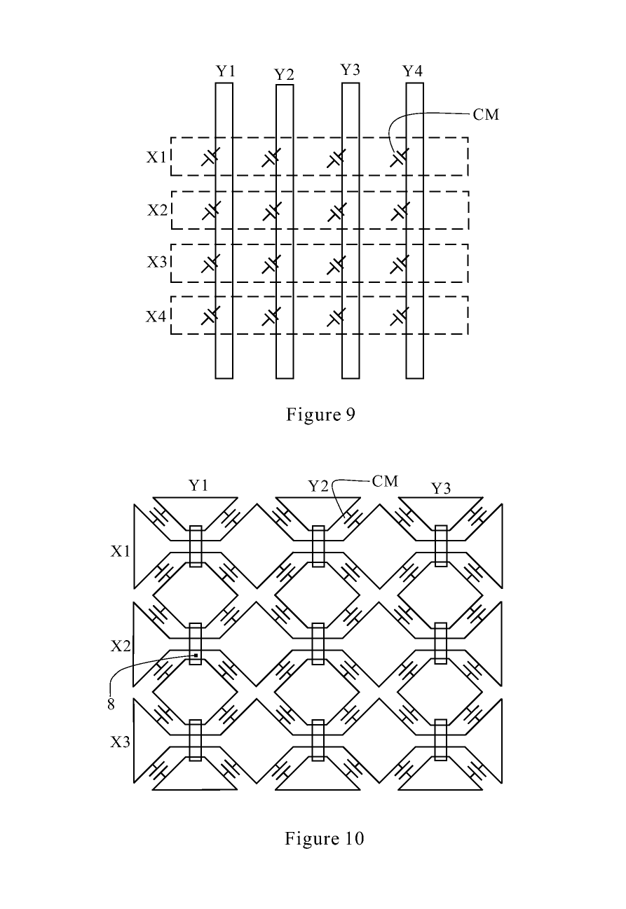

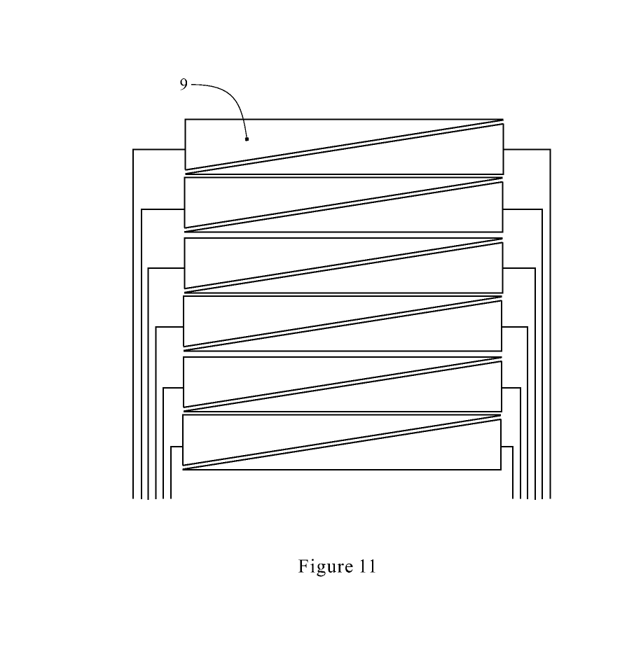

For the second embodiment as shown from FIG. 6 to FIG. 7, the said sub-electrode 211 is the rectangular sub-electrode 2112, and the said connecting electrode 212 is the rectangular connecting electrode 2121.

The said sub-electrode 211 can also be oval or oval-alike, or any axial symmetric figure whose boundary line is irregular with the first centre line as the symmetric axis, or any axial symmetric figure whose boundary line is irregular with the second centre line as the symmetric axis.

What is claimed is:

1. A single-layer electrode mutual capacitive touch screen, comprising at least one first-class electrode and at least one second-class electrode which are made of transparent conductive material, distributed in the same plane and coupled with each other, first connecting conductors made of transparent conductive material respectively electrically connected to the respective first-class electrode, second connecting conductors made of transparent conductive material respectively electrically connected to the respective second-class electrode, and data processing module; both of the said first-class electrodes and second-class electrodes are electrically connected to the data processing module; featuring that:
the said any first-class electrode and any second-class electrode are placed in the touch region of the said touch screen without overlapping each other; there is no positional relation of crossover, spanning and intersection between the first connecting conductors of the respective first-class electrode, the second connecting conductors of the respective second-class electrode, and connecting conductors of any first-class electrode and second-class electrode in the touch region of the touch screen.

2. The single-layer electrode mutual capacitive touch screen according to claim 1 is characterized in that:
the said data processing module is composed of a driving module for sending excitation signal, and a sensing module for receiving signal fed back from excitation signal; any of the said first-class electrode and second-class electrode is electrically connected to the said driving module, and another electrode is electrically connected to the said sensing module.

3. The single-layer electrode mutual capacitive touch screen according to claim 1 is characterized in that:
the said first-class electrodes are electrically connected to be the first electrode chains in serial in groups by virtue of the first connecting conductors, at least two respective centre lines of which are parallel; centre lines of the said first electrode chains are lines connecting centroids of the respective first electrodes which compose the first electrode chains; by virtue of the first connecting conductors which are electrically connected to the first-class electrodes at the end of the said first electrode chains, the said first electrode chains are electrically connected to the said data processing module;
the said second-class electrodes are set between the two adjacent first electrode chains and/or at the respective outside of the two most lateral first electrode chains; second connecting conductors electrically connecting respective second electrodes are set parallel to each other in the touch region of the touch screen, and are electrically connected to the said data processing module.

4. The single-layer electrode mutual capacitive touch screen according to claim 1 is characterized in that:
the said first-class electrodes are electrically connected to be the first electrode chains in serial in groups by virtue of the first connecting conductors, at least two respective centre lines of which are parallel; centre lines of the said first electrode chains are lines connecting centroids of the respective first-class electrodes composing the first electrode chains; by virtue of the first connecting conductors which are electrically connected to the first-class electrodes at the end of the said first electrode chains, the said first electrode chains are electrically connected to the said data processing module;
the said first-class electrode is provided with a hollow electrode accommodating area, and at least one wire slot is set for the first-class electrode, by virtue of the wire slot, the electrode accommodating area which is located in the said first-class electrode is connected to the area at the outside of the first-class electrode;
the said second-class electrodes are set inside of the electrode accommodating areas corresponding to the second-class electrodes, the second connecting conductors electrically connected to the said second-class electrodes are led out from the wire slots of the said first-class electrodes and are electrically connected to the said data processing module; and the second connecting conductors which are electrically connected to the respective second-class electrodes are set in parallel in the area outside of the first-class electrodes.

5. The single-layer electrode mutual capacitive touch screen according to claim 3 is characterized in that:
the said first-class electrodes are of planar shape; in one first electrode chain, planar borders of the adjacent first-class electrodes are electrically connected, i.e. there is no first connecting conductor between the adjacent first-class electrodes in the first electrode chains, thus, the first electrode chains are long striped.

6. The single-layer electrode mutual capacitive touch screen according to claim 4 is characterized in that:
the said first-class electrodes are of planar shape; in one first electrode chain, planar borders of the adjacent first-class electrodes are electrically connected, i.e. there is no first connecting conductor between the adjacent first-class electrodes in the first electrode chains, thus, the first electrode chains are long striped.

7. The single-layer electrode mutual capacitive touch screen according to claim 4 is characterized in that:
the said second-class electrode comprises at least two sub-electrodes, and the connecting electrode set between the adjacent two sub-electrodes;
the said sub-electrode is the plane with the first centre line and second centre line perpendicular to each other. Length of the first centre line segment AB for the said sub-electrode which is collinear with the first centre line is shorter than the length for the second centre line segment CD for the said sub-electrode which is collinear with the second centre line; respective second centre lines of the said sub-electrodes are set parallel to each other;
taking the direction where the second centre lines are located of the said sub-electrodes as the width direction, width of the said connecting electrode is smaller than the length of the second centre line segment CD which is collinear with the second centre lines of the said sub-electrodes;
planar borders between the said sub-electrodes and the connecting electrodes are electrically connected by virtue of the mutually adjacent planar borders, thus, the said second-class electrodes are of planar shape with at least one groove;
border shape of the electrode accommodating areas of the first-class electrodes corresponding to the said second-class electrodes are matched with the planar border shape of the second-class electrodes, thus border of the said electrode accommodating area is of zigzag shape.

8. The single-layer electrode mutual capacitive touch screen according to claim 7 is characterized in that:
the said sub-electrodes are diamond-alike sub-electrodes with opposite angles cut off, i.e. the said diamond-alike sub-electrode is a hexagon shaped from a diamond whose angles at both sides of the second centre line are cut off by a pair of straight lines which are parallel to the said second centre line; the said connecting electrodes are rectangular connecting electrodes.

9. The single-layer electrode mutual capacitive touch screen according to claim 7 is characterized in that:
the said sub-electrodes are rectangular sub-electrodes; and the said connecting electrodes are the rectangular connecting electrodes.

10. The single-layer electrode mutual capacitive touch screen according to claim 4 is characterized in that:
respective wire slots for the said first-class electrodes are placed at one side or both sides of the first electrode chains

11. The single-layer electrode mutual capacitive touch screen according to claim 1 is characterized in that:
the said transparent conductive material is Indium Tin Oxide, ITO for short, or Antimony Tin Oxide, ATO for short.
